(19) United States
(12) Patent Application Publication
(10) Pub. No.: US 2007/0205891 A1
(43) Pub. Date: Sep. 6, 2007

(54) NETWORK ENABLED RADIATION DETECTION SYSTEMS, METHODS OF MONITORING RADIATION, AND NETWORK ENABLED RADIATION MONITORING SYSTEMS

(76) Inventors: David F. Spencer, Idaho Falls, ID (US); Rahmat Aryaeinejad, Idaho Falls, ID (US)

Correspondence Address: BATTELLE ENERGY ALLIANCE, LLC, P.O. BOX 1625, IDAHO FALLS, ID, 83415-3899, US

(21) Appl. No.: 11/669,286

(22) Filed: Jan. 31, 2007

Related U.S. Application Data
(63) Continuation-in-part of application No. 10/687,466, filed on Oct. 15, 2003.
Application No. 10/687,466 is a continuation-in-part of application No. 09/742,964, filed on Dec. 20, 2000, now abandoned.

(51) Int. Cl. G08B 1/08; G08B 17/12

(52) U.S. Cl. 340/539.29; 340/600

(57) ABSTRACT

A network enabled radiation detection system includes a sensor configured for measuring radiation; a microprocessor configured for receiving data from the sensor related to radiation; memory operatively associated with the microprocessor; software code configured for time stamping data related to radiation, and for storing data, subsequent to time stamping, in the memory; and wireless communication equipment configured for transmitting a message with the data related to radiation to another device. A method of monitoring radiation with a network enabled radiation detection system includes measuring radiation with a sensor; receiving data into a microprocessor related to the radiation; time stamping the data related to radiation; storing the data in memory; and transmitting the data to a base station.

### CROSS-REFERENCE TO RELATED APPLICATION

This is a continuation-in-part of co-pending U.S. patent application Ser. No. 10/687,466, filed on October 15, 2003, entitled “Method and Apparatus for Detecting Neutrons and Gamma Rays” which is a continuation-in-part of U.S. patent application Ser. No. 09/742,964, filed on Dec. 20, 2000, entitled “Real Time Neutron and Gamma Ray Dosimeter,” (now abandoned), both of which are hereby incorporated herein by reference for all that they disclose.

### GOVERNMENT RIGHTS

This Invention was made under a Cooperative Research and Development Agreement between View Systems, Inc. and Battelle Energy Alliance, LLC under Contract No. DE AC05ID14517, awarded by the U.S. Department of Energy. The U.S. Government has certain rights in the invention.

### TECHNICAL FIELD

This invention relates to radiation detectors in general and more specifically to radiation detectors for providing real-time radiation data.

### BACKGROUND OF INVENTION

Radiation detection monitoring technologies are used by nuclear storage facilities to protect against a variety of unwanted events. Such safeguards are used to protect against a variety of unwanted events, such as theft of nuclear weapons, theft of special nuclear materials, and radiological sabotage. For more efficient operation, nuclear facilities require development and commercialization of cheaper, faster, and integrated smart radiation monitoring systems.

Radiation detectors for detecting high energy photons (e.g., gamma (γ) rays and X-rays) are well-known in the art and are used to detect high energy photons produced by any of a wide range of radioactive materials or other types of samples. The detection, identification, and spectroscopy of such energetic photons comprises an integral part of the fields of nuclear and particle physics as well as several fields that make use of radioactivity, including, for example, medicine, forensic science, and industrial inspection applications. Radiation detectors are also used at nuclear power plants and laboratories to monitor and study radiation.

Ionizing radiation detectors, such as gamma (γ) ray detectors, can be classified into one of three types depending on the apparatus that is used to detect the high energy photons. The first type, referred to herein as “gas tube” or simply “gas” detectors utilizes a gas-filled chamber or tube which contains a positively charged wire. When a high energy photon enters the chamber it may ionize a gas atom, causing it to release an electron or electrons in the process. The liberated electron or electrons may in turn ionize additional gas atoms, which liberate yet more electrons. The liberated electrons are collected by the positively charged wire. A detection circuit connected to the wire measures the charge delivered to the wire by the electrons. Generally speaking, the higher the energy of the incoming photon, the more atoms are ionized and the more electrons are liberated. Therefore, the magnitude of the detected charge is generally related to the energy of the incoming photon.

Solid state detectors are similar to gas detectors described above except that the active volume (i.e., the gas) is replaced by a semiconducting material, such as germanium, although other materials may be used. The third type of detector is a scintillation detector and may be either liquid or solid, inorganic or organic. All three types of detectors have in common the property that they use the energy of the incoming photon to ionize an atom of some material. Generally speaking, solid state detectors provide superior sensitivity and resolution compared with gas tube and scintillation detectors, although all three types remain in use.

Besides high energy photons, radiation can also comprise high energy particles, such as alpha (α) particles, beta (β) particles, and neutrons (n). Such high energy particle-type radiation is usually detected by other types of detectors. For example, neutrons are typically detected by using a radiator or converter which absorbs incoming neutrons and radiates charged particles. The radiated particles may then be detected by means of an ionizing type radiation detector of the type described above.

While radiation detectors for detecting high energy photons (e.g., gamma rays) and high energy particles (e.g., neutrons) exist and are being used, they are not without their problems. For example, a problem with prior art neutron detectors relates to the sensitivity of the detectors to gamma rays. Consequently, it is difficult for such detectors to discriminate (i.e., differentiate) between gamma rays and neutrons. Since both gamma and neutron radiation must be separately measured in order to accurately measure the radiation field, such neutron detectors are not particularly useful in accurately characterizing the radiation field.

One way to solve the problem of simultaneously measuring both gamma and neutron radiation is to utilize two separate detectors, one optimized for gamma ray detection and the other optimized for neutron detection. While such dual detector systems are known and have been used, they tend to be bulky, heavy, and difficult to carry. In addition, such devices tend to consume a fair amount of electrical power, thus limiting their usefulness, particularly in portable applications. While smaller, more portable detectors exist, they are typically only responsive to one type of radiation. Therefore, a user must carry two separate detectors if it is desired to monitor both gamma radiation and neutron radiation.

One other device that has been used is the neutron/gamma film badge. While such a badge is small and lightweight, thus very portable, it must be developed before the radiation dose can be ascertained. Consequently, film badges can only provide after-the-fact information, which can have tragic consequences in cases of acute radiation exposure.

Consequently, there remains a need for a radiation detection system that is capable of detecting and measuring both gamma radiation and neutron radiation, but yet is small and compact enough to be considered truly portable. Additional advantages could be realized if the radiation detector could provide a real-time assessment of radiation levels and also provide the user with an immediate warning if the radiation level exceeds a predetermined amount.

### SUMMARY OF THE INVENTION

In an embodiment, there is provided a network enabled radiation detection system, comprising a sensor configured for measuring a level of radiation in an area; a microprocessor in communication with the sensor, and configured for receiving data from the sensor related to the level of radiation; memory operatively associated with the microprocessor; software code operatively associated with the memory, the software code configured for time stamping the data related to the level of radiation, and for storing the data, subsequent to time stamping, in the memory; and wireless communication equipment operatively associated with the memory, and configured for transmitting a message with the data related to the level of radiation measured by the sensor, subsequent to time stamping, to another device.

In another embodiment, there is provided a method of monitoring radiation with a network enabled radiation detection system, the method comprising measuring a level of radiation in an area with a sensor; receiving data into a microprocessor from the sensor related to the level of radiation; time stamping the data related to the level of radiation; storing the data, subsequent to time stamping, in memory; and transmitting the data related to the level of radiation measured by the sensor, subsequent to time stamping, to a base station.

In yet another embodiment, there is provided a network enabled radiation monitoring system, comprising a base station; and at least two network enabled radiation detection systems, each one of the detection systems comprising a sensor configured for measuring a level of radiation in an area; a microprocessor in communication with the sensor, and configured for receiving data from the sensor related to the level of radiation; memory operatively associated with the microprocessor; software code operatively associated with the memory, the software code configured for time stamping the data related to the level of radiation, and for storing the data, subsequent to time stamping, in the memory; and wireless communication equipment operatively associated with the memory, and configured for transmitting a message with the data related to the level of radiation measured by the sensor, subsequent to time stamping, to the base station.

In still another embodiment, there is provided a communications system, comprising a base station with wireless communication equipment to transmit messages and receive messages, the base station having a set of transmission identifiers (ID) and a mask for identifying messages associated therewith; and a plurality of remote devices configured for communication with the base station, each one of the remote devices having a sensor, a mask associated therewith, and an identifier (ID) associated therewith.

In another embodiment, there is provided a method of communicating between a base station and a plurality of remote devices, the method comprising providing the base station with wireless communication equipment to transmit messages and receive messages, the base station having a set of transmission identifiers (ID) and a mask for identifying messages associated therewith; providing a plurality of remote devices configured for communication with the base station, each one of the remote devices having a sensor, a mask associated therewith, and an identifier (ID) associated therewith; loading, with the base station, the identifier (ID) for a selected one of the remote devices and send a message with the identifier (ID) for the selected one of the remote devices to all of the plurality of remote devices; applying, with the selected one of the remote devices, the mask associated therewith to the identifier (ID) with the message, detecting equality of the identifier (ID) and mask, and accepting the message; and applying, with each of the unselected ones of the remote devices, the mask associated therewith to the identifier (ID) with the message, detecting inequality of the identifier (ID) and the mask, and discarding the message.

### BRIEF DESCRIPTION OF THE DRAWINGS

Illustrative and presently preferred exemplary embodiments of the invention are shown in the drawings in which:

FIG. 1 is a perspective view of a first radiation detection system;

FIG. 2 is a block diagram of the radiation detection system of FIG. 1;

FIG. 3 is an enlarged cross-section of the Lithium-6 radiation detector;

FIG. 4 is an electrical schematic diagram of the amplifier system of the radiation detection system of FIG. 1;

FIG. 5 is an electrical schematic diagram of the discriminator system of the radiation detection system of FIG. 1;

FIG. 6 is a flow chart diagram of a radiation detection method utilized by the radiation detection system of FIG. 1;

FIG. 7 is a perspective view of a second radiation detection system;

FIG. 8 is a flow chart diagram of a radiation detection method utilized by the radiation detection system of FIG. 7;

FIG. 9 is a flow chart diagram of a method for generating rolling average counts of a detector;

FIG. 10 illustrates an exemplary embodiment of a network enabled radiation detection system;

FIG. 11 is a flow chart diagram of an exemplary embodiment of a method of monitoring radiation with a network enabled radiation detection system;

FIG. 12 illustrates an exemplary embodiment of a network enabled radiation monitoring system;

FIGS. 13-15 illustrate an exemplary embodiment of a communications system that includes a base station and remote devices with wireless communication equipment to transmit messages and receive messages; and

FIG. 16 is a flow chart diagram of an exemplary embodiment of a method of communicating between a base station and a plurality of remote devices.

### DETAILED DESCRIPTION OF THE PREFERRED EMBODIMENTS

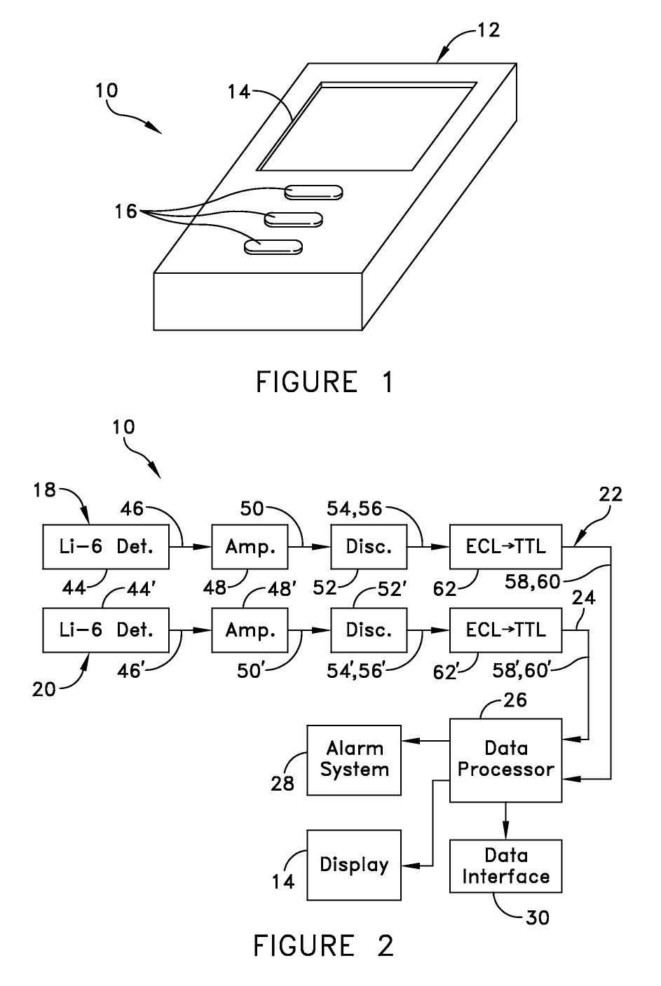

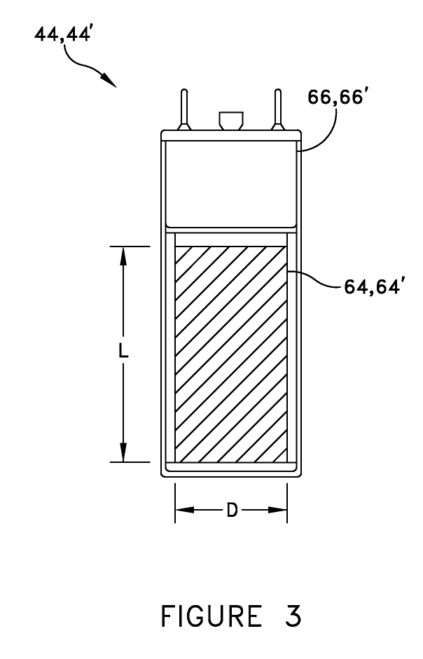

A radiation detection system 10 according to one embodiment of the present invention is best seen in FIGS. 1 and 2 and may comprise a small, palm-sized housing 12 sized to receive the various internal components and systems of the radiation detection system 10. The housing 12 may be provided with a display device 14, such as a liquid crystal display, for displaying the measured radiation levels as well as for displaying various information and data relating to the operation of the detection system. In addition, the housing 12 may be provided with one or more selection switches or buttons 16 to allow the user (not shown) to control the function and operation of the radiation detection system 10 in the manner that will be more fully described below. While the housing 12 of the radiation detection system 10 is configured to be hand-held, the housing 12 also may be provided with a suitable clip or bracket (not shown) to allow the user to secure the device to his person (e.g., via a belt) thus freeing the hands of the user and allowing the user to conveniently carry the radiation detection system 10 into known or suspected radiation fields.

With reference now primarily to FIG. 2, one embodiment of the radiation detection system 10 may comprise two separate radiation detection devices or systems 18 and 20. The first radiation detection device or system 18 is sensitive or responsive to both neutrons (n) and to gamma (γ) radiation and produces an output signal 22 that includes neutron counts and gamma counts. The second radiation detection device or system 20 is sensitive or responsive to gamma radiation and produces an output signal 24 that includes gamma counts. Both radiation detection systems 18 and 20 are operatively connected to a data processing system 26 which is used to calculate a number of different radiation levels and parameters. For example, in the embodiment shown and described herein, the data processing system 26 calculates a total count of both neutron radiation and gamma radiation. The data processing system 26 also calculates the rate of radiation (i.e., counts per unit time) for both neutron and gamma radiation.

The radiation detection system 10 may be provided with an alarm system 28 that is operatively associated with the data processing system 26. The alarm system 28 produces an alarm signal (e.g., a visual signal, an aural signal, or a tactile signal, or any combination thereof) if the radiation counts and/or count rates exceed certain predetermined thresholds. In the embodiment shown and described herein, the radiation detection system 10 is also provided with a data interface system 30 to allow data collected by the detection system 10 to be transferred or downloaded to a separate computer system (not shown) for further analysis.

The data processing system 26 continuously checks for various alarm conditions at step 40 and activates the alarm system 28 (FIG. 1) if one or more alarm conditions are detected during the radiation monitoring process 32. For example, in the embodiment shown and described herein, the data processing system 26 continuously checks the neutron and gamma radiation total counts and total count rates against corresponding predetermined thresholds. If any radiation total count rate exceeds its corresponding threshold, the data processing system 26 activates the alarm system 28 to alert the user that the total count or rate has exceeded the threshold.

The data processing system 26 continuously displays the various counts (i.e., neutron, gamma, and total) as well as the rates (i.e., neutron, gamma, and total) on the display system 14, as depicted in step 42. The data processing system 26 continuously repeats the method 32, thereby providing the user with real-time data relating to both the total radiation count and the count rate. The continual repetition of the process 32 also allows the alarm system 28 to be activated the moment one or more of the radiation counts or count rates exceed their respective thresholds.

A significant advantage of the radiation detection system 10 according to the present invention is that it provides, in a single, highly portable unit, the ability to detect and display, in real-time, data relating to both neutron and gamma radiation. Consequently, the radiation detection system 10 dispenses with the need for the user to carry multiple radiation detectors. Moreover, by providing the user with immediate data relating to radiation exposure, the radiation detection system 10 substantially reduces the risk that the user will be unknowingly exposed to excessive radiation levels while awaiting the results from non real-time radiation detectors, such as film badges.

Another advantage of the radiation detection system 10 is that it continuously checks the radiation levels against predetermined threshold levels and activates the alarm system 28 if any of the radiation levels exceeds the threshold level for that particular type of radiation. As a result, the radiation detection system 10 of the present invention allows the user to take immediate action (such as leaving the area) upon activation of the alarm signal. Another advantage associated with the alarm system 28 is that it may be programmed to provide the user with several different types of alarm signals, or combinations of alarm signals, depending on the particular environment in which the detection system 10 is to be used. For example, in the embodiment shown and described herein, the alarm system 28 may be user-programmed to provide a visual alarm signal(e.g., a flashing light), an aural alarm signal (a tone or buzzer), a tactile alarm signal (e.g., a vibration) or any combination of the these signals.

Still yet another advantage of the radiation detection system 10 is that the data interface system 30 allows information and data relating to the measured radiation levels to be transferred or downloaded to a separate computer system for later logging and analysis. Accordingly, the radiation detection system 10 provides a convenient means for collecting and analyzing data from the radiation field that surrounded the detection system 10.

Having briefly described the radiation detection system 10, as well as some of its more significant features and advantages, the various embodiments of the radiation detection system according to the present invention will now be described in detail.

Referring back now to FIGS. 1 and 2, one embodiment 10 of the radiation detection system of the present invention may comprise a palm-sized, generally rectangularly shaped housing 12 within which is contained the various components and systems of the radiation detection system 10. Alternatively, of course, other housing shapes and configurations are possible. The housing 12 may be provided with a display system 14, such as a liquid crystal display, suitable for displaying the detected radiation levels, as well as any other information and data relating to the function and operation of the detection system 10. The housing 12 may also be provided with one or more switches or buttons 16 which may be activated by the user (not shown) to control the function and operation of the radiation detection system 10. Finally, the housing 12 may also contain a suitable power supply system (e.g., batteries) for providing electrical power to the various components and systems of the radiation detection system 10.

The housing 12 may be made from any of a wide variety of materials (e.g., metals or plastics) suitable for the intended application. Preferably, the housing material should be relatively transparent to the type of radiation (e.g., neutron and gamma) that is to be detected by the detection system 10. By way of example, in one preferred embodiment, the housing 12 is formed from aluminum. Alternatively, other materials could be used, as would be obvious to persons having ordinary skill in the art after having become familiar with the teachings of the present invention.

The display system 14 may comprise any of a wide range of display systems now known in the art or that may be developed in the future suitable for displaying the radiation levels and other information relating to the operation of the detection system 10. Moreover, the size, shape, and display capacity of the display system 14 may be varied in accordance with the desired functionality of the radiation detection system 10 as well as on the type and amount of data that is to be presented to the user. Consequently, the present invention should not be regarded as limited to any particular type of display device having any particular size. However, by way of example, in one preferred embodiment, the display system 14 comprises a two-dimensional liquid crystal display (LCD) of the type that is readily commercially available. Of course, display systems of other types and/or configurations may be used depending on the desired configuration and size of the detection system 10.

The control switches or buttons 16 that may be used to control the function and operation of the radiation detection system 10 may also comprise any of a wide range of switch devices that are now known in the art or that may be developed in the future. In addition, the number, size, and placement of the control switches or buttons 16 may be varied depending on the functionality and operational features that are to be provided to the radiation detection system 10. Consequently, the present invention should not be regarded as limited to the particular number and configuration of the switches 16 shown and described herein.

With reference now primarily to FIG. 2, the radiation detection system 10 is provided with two separate radiation detection systems 18 and 20. The radiation detection systems 18 and 20 are responsive to different types or kinds of radiation. For example, in one preferred embodiment, the first radiation detection system 18 is sensitive or responsive to both gamma radiation and to neutron radiation. The first radiation detection system 18 produces an output signal 22 that contains data (e.g., counts) relating to both gamma radiation and neutrons. The second radiation detection system 20 is sensitive or responsive to gamma radiation and produces an output signal 24 that contains data relating to gamma radiation. As will be described in greater detail below, the data relating to neutron and gamma radiation is uncoupled by the data processing system 26, thereby allowing the detection system to produce separate data relating to neutron radiation and gamma radiation.

The first radiation detection system 18 may comprise a radiation detector 44 that is responsive or sensitive to both neutrons and to gamma radiation. The radiation detector 44 produces an output signal 46 that is related to the number of events or “counts” detected by the detector 44. An amplifier 48 connected to the radiation detector 44 amplifies the output signal 46 produced by the detector 44, resulting in an amplified signal 50. The amplified signal 50 is applied to a discriminator circuit 52 which produces upper and lower level discriminated signals 54 and 56. The discriminated signals 54 and 56 are then converted into corresponding TTL signals 58, 60 by an ECL/TTL converter circuit 62 before being directed to the data processing system 26. Each of the foregoing components and systems will now be described in detail.

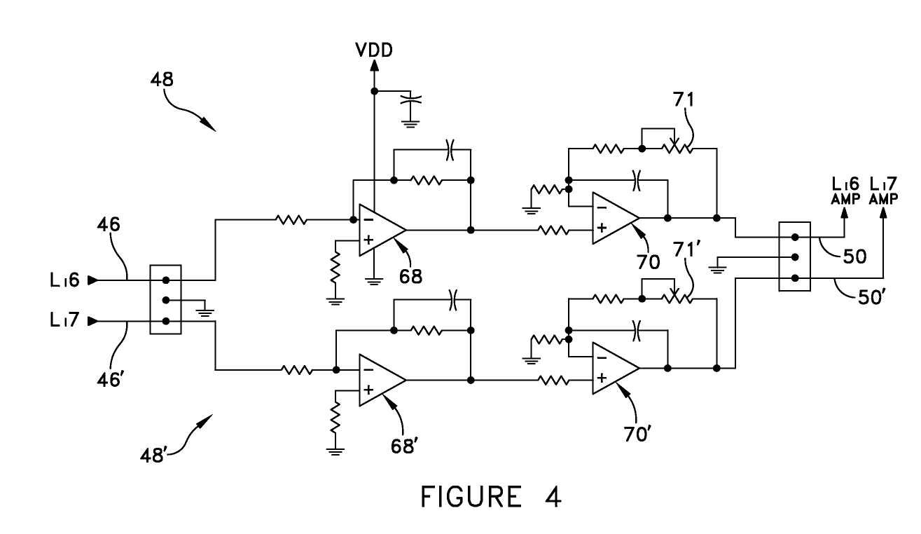

The radiation detector 44 is best seen in FIG. 3 and may comprise a glass-type scintillator 64 having an integral photomultiplier tube 66 associated therewith. The glass scintillator 64 is doped with a small quantity of lithium-6 and may be referred to herein as a lithium-6 loaded glass scintillator. Besides being sensitive to gamma radiation, the lithium-6 isotope is also sensitive to neutrons. Accordingly, the Li-6 detector 44 is sensitive to both gamma radiation and to neutrons.

The sensitivity of the detector 44 is generally related the size and shape of the lithium-6 scintillator 64, with smaller scintillators being generally less sensitive to gamma radiation and to neutrons. While any of a wide range of sizes of scintillators 64 may be utilized depending on the desired degree of sensitivity, in one preferred embodiment the lithium-6 scintillator 64 has a diameter D of about 12.5 mm (0.5 inches) and a length L of about 12.5 mm (0.5 inches). The sensitivity of the detector 44 to neutrons may be measured in terms of its Q-value, which is a measure of disintegration energy. The Q-value for neutron capture for the scintillator 64 having the above-identified dimensions is about 4.8 MeV. Consequently, a neutron capture in detector 44 produces a high amplitude signal. Gamma ray interaction with the detector 44 produces a signal with a different amplitude that is proportional to the energy of the gamma ray. Moreover, the sensitivity of the detector 44 is much greater for low energy gamma rays than for high energy gamma rays. Altogether, lower level signals from the detector 44 are generally indicative of gamma radiation, whereas higher level signals may be indicative of either gamma radiation or neutron radiation. However, since radiation detectors of the type described above (i.e., detectors having glass scintillators with integral photomultiplier tubes) are known in the art and could be easily provided by persons having ordinary skill in the art after having become familiar with the teachings of the present invention, the radiation detector 44 utilized in one preferred embodiment of the radiation detection system 10 will not be described in further detail herein.

It is generally preferred to encapsulate the Li-6 detector 44 in a moderating material, such as polyethylene, which thermalizes fast neutrons, thus allowing the detector 44 to measure both fast and slow neutrons. Alternatively, other materials may also be used.

As mentioned above, the radiation detector 44 produces an output signal 46 that is indicative of the number of events or counts detected by the detector 44. This output signal 46 is filtered and amplified by the amplifier 48 which produces an amplified signal 50. The low-level output signal 46 (which, in the embodiment shown and described herein may comprise a signal having an amplitude of about −250 millivolts) from the detector 44 is first fed through an inverting filter/integration stage 68 having a DC gain of about −0.5. The inverting filter/integration stage 68 inverts the signal 46 and removes a portion of the high-frequency noise which may be contained in the signal 46. Thereafter, the inverted, filtered signal is fed to a positive, variable gain amplifier 70. The gain of the amplifier 70 may range between +2 and +12 and may be adjusted via potentiometer 71. The gain of the amplifier 70 is set so that amplified signals from both detectors 44 and 44′ have about the same amplitude. In the embodiment shown and described herein, the amplified signal 50 from the amplifier 48 comprises a series of positive pulses having maximum amplitudes of about +1 volt. Alternatively, the amplified signal 50 may have other amplitudes, depending on the particular circuitry that is involved.

The amplifier circuits 68 and 70 for performing the above-described amplification functions may comprise any of a wide range of amplifier circuits now known in the art or that may be developed in the future. Consequently, the present invention should not be regarded as limited to the particular amplifier circuits shown and described herein. However, by way of example, the amplifiers 68 and 70 in one embodiment of the invention may comprise two of the four individual operational amplifiers available on a quad op-amp chip, such as type OP492 available from Analog Devices. 53

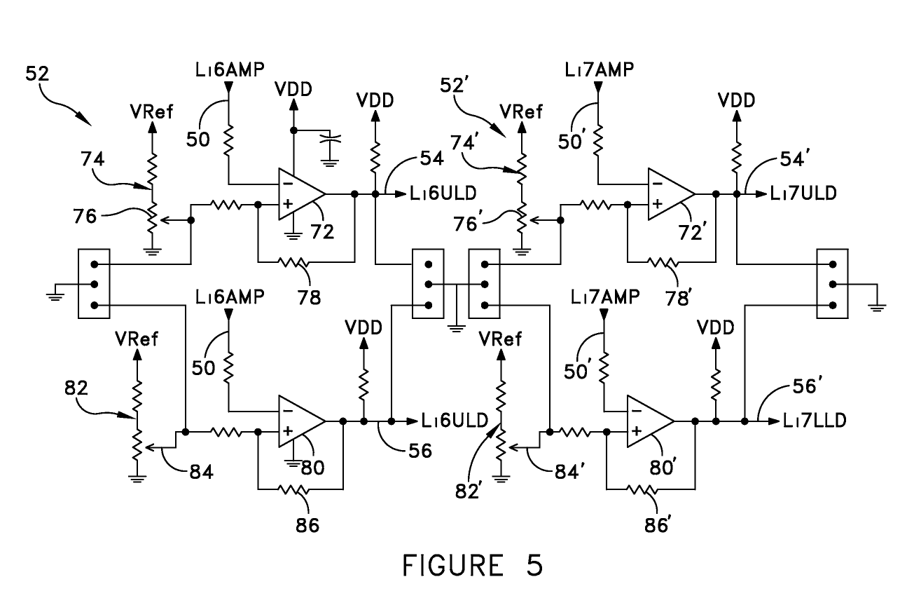

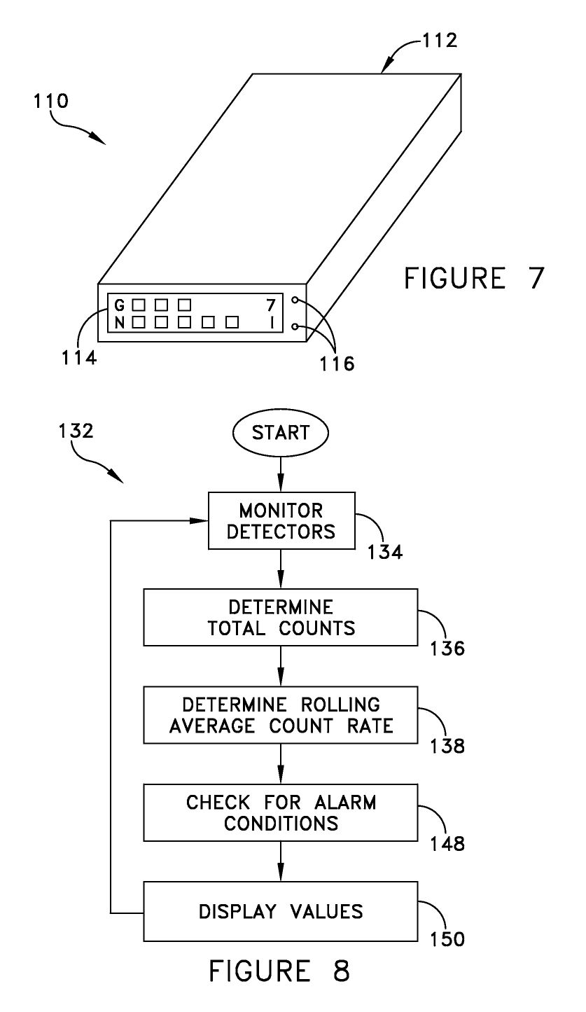

The amplified signal 50 from the lithium-6 detector 44 is then fed into discriminator circuit 52. Discriminator circuit 52 discriminates or divides the signal 50 into an upper level discriminated signal 54 (Li6ULD) and a lower level discriminated signal 56 (Li6LLD). See FIG. 6. Before proceeding with the description it should be noted that the lower level discriminated signals (i.e., Li6LLD and Li7LLD) are useful in eliminating electronic noise. That is, any signal above the threshold of the lower level discriminated signals are used to calculate gamma and total exposure. The upper level discriminated signals (i.e., Li6ULD and Li7ULD) are used to calculate the neutron exposure. Continuing now with the description, the upper level discriminated signal 54 (Li6ULD) is produced by a first comparator 72. The inverting input (i.e., the “−” terminal) of comparator 72 is connected to the amplified signal 50 (Li6Amp) from the amplifier 70 (FIG. 4). The non-inverting input (i.e., the “+” terminal) is connected to a voltage divider network 74 which allows a variable reference voltage to be selected by means of a potentiometer 76. A feedback resistor 78 is connected between the output of comparator 72 and the non-inverting input to provide hysterisis, thus stabilize the output of the comparator 72. Basically, then, comparator 72 operates as a Schmitt trigger.

The lower level discriminated signal 56 (Li6LLD) is produced by a second comparator 80. The inverting input (i.e., the “−” terminal) of comparator 80 is also connected to the amplified signal 50 from the amplifier 70 (FIG. 4). The non-inverting input (i.e., the “+” terminal) of comparator 80 is connected to a second voltage divider network 82 which allows a variable reference voltage to be selected by means of a second potentiometer 84. Hysterisis is provided by a feedback resistor 86 connected between the output of comparator 80 and the non-inverting input of the comparator 80. Comparator 80 also operates as a Schmitt trigger.

The comparators 72 and 80 for performing the above-described discrimination functions may comprise any of a wide range of devices now known or that may be developed in the future. By way of example, in the embodiment shown and described herein, the comparators 72 and 80 may comprise two of the four individual operational amplifiers available on a quad op-amp integrated circuit, such as type TLC354CN available from Texas Instruments. Alternatively, other types of circuits may be used, as would be obvious to persons having ordinary skill in the art after having become familiar with the teachings of the present invention.

The upper and lower level discriminated signals 54 and 56 produced by the discriminator circuit 52 comprise a series of narrow pulses (e.g., pulses in the nano-second range) at about 0 Volts D.C. (Vdc) when triggered and at 5 Vdc when not triggered. The upper and lower level discriminated signals 54 and 56 are converted into TTL signals by a pair of monostable (i.e., “one-shot”) multivibrators (not shown). Each one-shot multivibrator (not shown) converts the pulses contained in the upper and lower level discriminated signals 54 and 56 into a pulses having widths of about 10 microseconds (μs), which are suitable for TTL circuits. The one-shot multivibrators may comprise any of a wide range of circuits and devices that are readily commercially available. By way of example, in one preferred embodiment, the two one-shot multivibrators may comprise those contained on a 74HC123 integrated circuit available from Texas Instruments. Alternatively, other types of one-shot circuits could be used, as would be obvious to persons having ordinary skill in the art after having become familiar with the teachings of the present invention. Since such one-shot circuits are well-known in the art and may be easily provided by persons having ordinary skill in the art after having become familiar with the teachings of the present invention, the one-shot multivibrator circuits that may be utilized in one embodiment of the invention will not be described in further detail herein.

The second radiation detection system 20 is similar to the first radiation detection system 18 just described and may comprise a radiation detector 44′ that is responsive or sensitive to gamma radiation. The radiation detector 44′ produces an output signal 46′ that is related to the number of gamma events or “counts” detected by the detector. An amplifier 48′ connected to the radiation detector 44′ amplifies the output signal 46′, producing an amplified signal 50′. The amplified signal 50′ is applied to a discriminator circuit 52′ which produces upper and lower level discriminated signals 54′ and 56′. The discriminated signals 54′ and 56′ are then converted into TTL signals 58′, 60′ by an ECL/TTL converter circuit 62′ before being directed to the data processing system 26.

With reference back now to FIG. 3, the radiation detector 44′ is similar to the radiation detector 44 described above and may comprise a glass-type scintillator 64′ having an integral photomultiplier tube 66′. The glass scintillator 64′ is doped with a small quantity of lithium-7 and may be referred to herein as a lithium-7 loaded glass scintillator. Unlike the lithium-6 isotope contained in the first detector 44, the lithium-7 isotope in the second detector 44′ is sensitive only to gamma radiation. Accordingly, the Li-7 detector 44′ is sensitive primarily only to gamma radiation. The sensitivity of the detector 44′ is generally related the size and shape of the lithium-7 scintillator 64′, with smaller scintillators being generally less sensitive to gamma radiation. While any of a wide range of sizes of scintillators 64′ may be utilized, depending on the desired degree of sensitivity, in one preferred embodiment the lithium-7 scintillator 64′ has a diameter D of about 12.5 mm (0.5 inches) and a length L of about 12.5 mm (0.5 inches).

Since radiation detectors of the type described above (i.e., detectors having glass scintillators with integral photomultiplier tubes) are known in the art and are commercially available, the radiation detector 44′ utilized in one preferred embodiment of the radiation detection system 10 will not be described in further detail herein.

The radiation detector 44′ produces an output signal 46′ (e.g., comprising pulses of about −250 millivolts) that is indicative of the amount of gamma radiation (referred to herein as counts) detected by the detector 44′. This output signal 46′ is filtered and amplified by the amplifier 48′ to produce an amplified signal 50′. The amplifier 48′ may be substantially identical to the amplifier 48 already described and may comprise an inverting filter/integration stage 68′ having a DC gain of about −0.5. The inverting filter/integration stage 68′ inverts the signal and removes a portion of the high-frequency noise which may be contained in the signal 46′. Thereafter, the inverted, filtered signal is fed to a positive, variable gain amplifier 70′. The gain of the amplifier 70′ may range between +2 and +12 and is used to perform gain matching of the signals from both detectors 44 and 44′. The gain of amplifier 70′ may be adjusted by means of potentiometer 71′. As was the case for the first amplified signal 50, the amplified signal 50′ from the amplifier 48′ comprises positive pulses with maximum amplitudes of about +1 volt.

The amplifiers 68′ and 70′ for performing the above-described amplification functions may comprise any of a wide range of amplifiers now known or that may be developed in the future. By way of example, in the embodiment shown and described herein, the amplifiers 68′ and 70′ comprise the remaining two operational amplifiers contained on the quad op-amp integrated circuit (e.g., type OP492 available from Analog Devices).

The amplified signal 50′ from the lithium-7 detector 44′ is then fed into discriminator circuit 52′ which discriminates or divides the signal 50′ into an upper level discriminated signal 54′ (Li7ULD) and a lower level discriminated signal 56′ (Li7LLD). See FIG. 6. The discriminator circuit 52′ may be substantially identical to the discriminator circuit 52 described above and may comprise a first comparator 72′, the inverting input (i.e., the “−” terminal) of which is connected to the amplified signal 50′ (Li7Amp) from the amplifier 70′ (FIG. 4). The non-inverting input (i.e., the “+” terminal) of amplifier 70′ is connected to a voltage divider network 74′ which allows a variable reference voltage to be applied to the non-inverting input by means of a potentiometer 76′. A feedback resistor 78′ connected between the output of comparator 72′ and the non-inverting (i.e., +) input provides hysterisis, thus stabilizing the output of the comparator 72′.

The lower level discriminated signal 56′ (Li7LLD) is produced by a second comparator 80′, the inverting input of which is also connected to the amplified signal 50′ from the amplifier 70′ (FIG. 4). The non-inverting input of comparator 80′ is connected to a second voltage divider network 82′ which allows a variable reference voltage to be provided to the non-inverting input by means of a second potentiometer 84′. Hysterisis is provided by a feedback resistor 86′ that connected between the output of comparator 80′ and the non-inverting input of the comparator 80′.

The comparators 72′ and 80′ for performing the above-described discrimination functions may comprise any of a wide range of devices now known or that may be developed in the future. By way of example, in the embodiment shown and described herein, the comparators 72′ and 80′ may comprise the remaining two of the four individual operational amplifiers available on the type TLC354 quad op-amp chip that was utilized for the first discriminator circuit 52. Alternatively, of course other arrangements and circuits may be used, as would be obvious to persons having ordinary skill in the art after having become familiar with the teachings of the present invention.

The upper and lower level discriminated signals 54′ and 56′ produced by the discriminator circuit 52′ comprise a series of narrow pulses (in the nano-second range) having amplitudes of about 0 Volts D.C. (Vdc) when triggered and about 5 Vdc when not triggered.

The upper and lower level discriminated signals 54′ and 56′ are converted into TTL signals by a pair of monostable (i.e., “one-shot”) multivibrators (not shown). Each one-shot multivibrator (not shown) converts the pulses contained in the upper and lower level discriminated signals 54′ and 56′ into a pulses having widths of about 10 microseconds (μs), which are suitable for TTL circuits. Again, since one-shot multivibrators are well known in the art and may be easily provided by persons having ordinary skill in the art after having become familiar with the teachings of the present invention, the one-shot multivibrators that may be utilized in one preferred embodiment of the present invention will not be described in further detail herein.

The data processing system 26 is connected to the first and second radiation detection systems 18 and 20 and is responsive to the output signals 22 and 24 produced by the respective radiation detection systems 18 and 20. The data processing system 26 determines both the total radiation exposure (i.e., count) as well as the rate of accumulation of the counts (i.e., counts per unit time), and presents the data on the display device 14. The data processing system 26 also continuously checks the radiation counts and count rates against corresponding count and rate thresholds and activates the alarm system 28 if any parameter exceeds its respective threshold value.

In accordance with the functionality described above, the data processing system 26 may comprise any of a wide range of devices and systems that are now known in the art or that may be developed in the future that would be suitable for performing the functions and operations described herein. Consequently, the present invention should not be regarded as limited to any particular type or style of data processing system 26. However, by way of example, the data processing system 26 utilized in one preferred embodiment of the invention may comprise a type 16C64A erasable PIC device available from Microchip Devices.

The output signals 22 and 24 (comprising TTL pulses) from the first and second detector systems 18 and 20 are fed directly to the data processing system 26 and are counted thereby. In the embodiment shown and described herein, the maximum pulse frequency that may be counted is about 33 kilohertz (kHz). This is due to both the width of the one-shot pulse (−10 μs) and the clock frequency of the data processing system (20 MHZ). Of course, the maximum pulse frequency could be increased or decreased by making the appropriate circuit and clock frequency changes.

The function and operation of the data processing system 26 may be controlled by means of the switches or buttons 16 provided on the housing 12. See FIG. 1. The switches 16 may be operated in accordance with information and data displayed on the display system 14 to accomplish any of a wide range of functions and operations. For example, in the embodiment shown and described herein, the buttons or switches 16 may be used to select the radiation parameters that are to be continuously displayed. Alternatively, the buttons or switch 16 may also be used to select or set the threshold values or each radiation parameter and/or to select the particular type of alarm signal that is to be used if one or more of the radiation parameters exceeds the corresponding threshold value. However, since such switch and display interface systems are well-known in the art and could be readily provided by persons having ordinary skill in the art after having become familiar with the teaching of the present invention, the particular architecture and operational logic that may be utilized by the switch and display interface system to control the function and operation of the data processing system 26 will not be described in further detail herein.

The data processing system 26 monitors the output signals 22 and 24 produced by the first and second radiation detection systems 18 and 20 to calculate several different radiation parameters. For example, the total count (both neutrons and gamma radiation) is determined or calculated by adding together the lower level discriminated signals 60 and 60′ (i.e., Li6LLD and Li7LLD) for both the Li6 and Li7 detectors 44 and 44′. The neutron count is calculated by subtracting the upper level discriminated signal 58′ (Li7ULD) from the Li7 detector 44′ from the upper level discriminated signal 58 (Li6ULD) from the Li6 detector 44. The gamma count is calculated by subtracting the neutron count from the total count.

The alarm system 28 provides the user (not shown) with several different alarm signals if one or more of the radiation parameters exceeds a corresponding threshold level. In the embodiment shown and described herein, the alarm system 28 may be controlled by the data processing system 26 to produce one or a combination of three distinct alarm signals. A first alarm signal comprises a visual signal, such as a flashing icon, that is displayed on the display device 14. Alternatively, a separate light source, such as an LED (not shown), may be provided that illuminates upon the alarm condition. A second alarm signal may comprise an audible alarm, such as may be generated by a small speaker (not shown). The third alarm signal may comprise a tactile signal, such as a vibration, induced by a suitable vibration transducer (not shown) that may be mounted within the housing 12. As mentioned above, the data processing system 26 may be programmed in advance by the user (via the buttons 16) to activate any of the alarm signals, either alone or in combination with the others, in order to alert the user that one or more of the radiation parameters has exceeded the corresponding threshold.

Since devices, such as those described above, for generating the foregoing alarm signals are well-known in the art and could be easily provided by persons having ordinary skill in the art after having become familiar with the teachings of the present invention, the devices for generating the three different types of alarm signals will not be discussed in further detail herein.

The radiation detection system 10 may also be provided with a data interface system 30 to allow data captured by the radiation detection system 10 to be transferred or downloaded to a separate computer system for logging and/or subsequent analysis. The data interface system 30 may comprise any of a wide range of data interface systems, such as wired data transfer systems or wireless (e.g., infrared) data transfer systems, that are currently well-known in the art or that may be developed in the future. Consequently, the present invention should not be regarded as limited to any particular type or style of data interface. However, by way of example, in one preferred embodiment, the data interface system 30 may comprise an infrared data transfer system or the RS-232 serial data protocol.

The radiation detection system 10 may be operated in accordance with the method 32 illustrated in FIG. 6 in order to determine exposure to both neutron radiation and gamma radiation. The method 32 may be implemented by programming the data processing system 26 in any convenient language (e.g., the “C” program language). Alternatively, of course, other programming languages could be used, as would be obvious to persons having ordinary skill in the art.

In the first step 34, the data processing system 26 monitors the two radiation detection systems 18 and 20 by sensing the output signals 22 and 24 produced by the respective first and second radiation detection systems 18 and 20. The output signal 22 produced by the first radiation detection system 18 includes data relating to both neutron counts and to gamma counts, whereas the output signal 24 produced by the second radiation detection system 20 includes data relating to gamma counts.

The data processing system 26 calculates or determines the total radiation exposure or count in step 36. First, the data processing system 26 determines neutron counts by subtracting the gamma radiation counts detected by the second radiation detection system 20 (i.e., the Li-7 detector 44′) from the gamma radiation and neutron counts detected by the first radiation detection system 18 (i.e., the Li-6 detector 44).

The data processing system 26 also calculates the gamma radiation count. First, the data processing system calculates a total radiation count by summing the gamma radiation counts detected by the second radiation detection system 20 (i.e., the Li-7 detector 44′) and the gamma radiation and neutron counts detected by the first radiation detection system 18 (i.e., the Li-6 detector 44). Then, the data processing system 26 subtracts the neutron count (calculated earlier) from the total count to yield a gamma count.

The data processing system 26 calculates the radiation rate (e.g., count/unit time) in step 38. Specifically, the neutron rate may be calculated by dividing the neutron count by a predetermined time interval.

The data processing system 26 continuously checks for various alarm conditions at step 40 and activates the alarm system 28 (FIG. 1) if one or more alarm conditions are detected during the radiation monitoring process 32. For example, in the embodiment shown and described herein, the data processing system 26 continuously checks the neutron and gamma radiation counts and count rates against corresponding predetermined thresholds. If any radiation counts or count rate exceeds its corresponding threshold, the data processing system 26 activates the alarm system 28 to alert the user that the count or count rate has exceeded the corresponding threshold.

The data processing system 26 continuously displays the various counts (i.e., neutron, gamma, and total) as well as the count rates (i.e., neutron, gamma, and total) on the display system 14, as depicted in step 42. The data processing system 26 continuously repeats the method 32, thereby providing the user with real-time data relating to both the total radiation count and the count rate. The continual repetition of the process 32 also allows the alarm system 28 to be activated the moment one or more of the radiation counts or count rates exceed their respective thresholds.

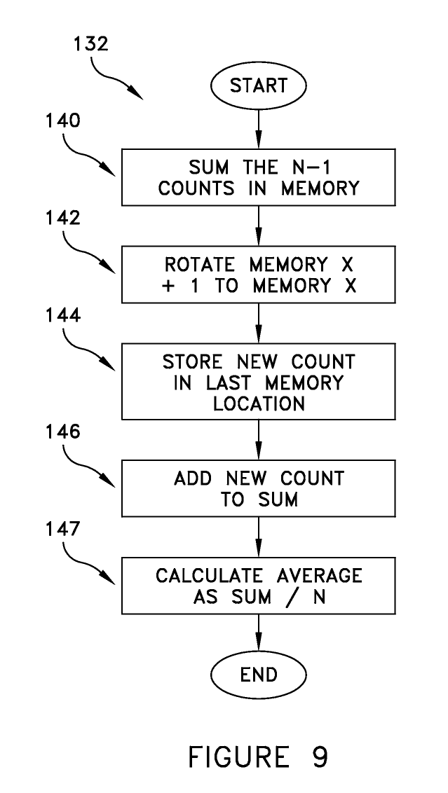

A second radiation detector 110 illustrated in FIG. 7 is specifically designed to be smaller, lighter, have an extended battery life and be and less-expensive to manufacture than the radiation detector 10 already described. The second radiation detector 110 is intended to be clipped onto a belt for complete hands-free operation by law-enforcement and special forces personnel to detect the presence of neutron and gamma-ray radiation fields and their relative intensities. As such, the second radiation detector 110 may be used advantageously to detect the presence of a radioactive source, as well as the type of radiation (e.g., neutron, gamma, or a combination of neutron and gamma) produced by the source.

In the embodiment illustrated in FIG. 7, the radiation detector 110 may comprise a small, pocket-sized housing 112 sized to receive the various internal components and systems of the radiation detector 110. The housing 112 may be made from any of a wide variety of materials (e.g., metals or plastics, or combinations thereof) suitable for the intended application. The housing 112 should be made of a material which facilitates the detection of neutrons, such as polyethylene.

The housing 112 is provided with a display device 114, such as a liquid crystal display, for displaying the measured radiation levels for both gamma-rays and neutrons. The display device 114 displays the relative intensities of the gamma-ray and neutron radiation levels in numeric and bar-graph format to allow a user (not shown) to readily determine the presence, strength, and type (e.g., gamma ray or neutron) of a radiation field.

The radiation detector 110 may also be provided with one or more control switches 116 that may be used to control the function and operation of the radiation detector 110. By way example, one embodiment of the radiation detector 110 is provided with a power switch and a sensitivity switch. The power switch turns the radiation detector on and off, whereas the sensitivity switch changes the sensitivity of the detector 110 among low, medium, and high sensitivity settings. Other user-operated control switches (not shown) may also be provided depending on the desired functionality of the radiation detector. Consequently, the present invention should not be regarded as limited to the particular number and configuration of the switches 16 shown and described herein.

The radiation detector 110 may be provided with two separate radiation detection systems (e.g., 18 and 20) that may be substantially identical to the radiation detection systems 18 and 20 provided in the radiation detector 10 already described and illustrated in FIGS. 2-5. That is, the first radiation detection system 18 may comprise a radiation detector (e.g., 44) that is primarily sensitive to both gamma radiation and to neutrons. In one embodiment, the radiation detector 44 comprises a glass-type scintillator (e.g., 64) having an integral photomultiplier tube (e.g., 66) associated therewith, as best seen in FIG. 3. The scintillator 64 is doped with a small quantity of lithium-6 which makes it sensitive to both gamma radiation and to neutrons. The various dynodes (not shown) contained in the photomultiplier tube 66 are connected to a Cockroft-Walton voltage multiplier circuit (also not shown) provided in the detector 110. However, because Cockroft-Walton voltage multiplier circuits are well-known in the art, and could be easily provided by persons having ordinary skill in the art after having become familiar with the teachings of the present invention, the particular Cockroft-Walton voltage multiplier circuit that is utilized in one embodiment will not be described in further detail herein.

The second radiation detection system 20 may comprise a radiation detector (e.g., 44′) that is substantially sensitive to gamma radiation only. In one embodiment, the radiation detector 44′ comprises a glass-type scintillator (e.g., 64′) having an integral photomultiplier tube (e.g., 66′) associated therewith. See FIG. 3. The scintillator 64′ is doped with a small quantity of lithium 7 which makes it substantially sensitive to gamma radiation only. The various dynodes (not shown) of the photomultiplier tube 66′ may also be connected to the Cockroft-Walton voltage multiplier circuit.

The radiation detector 110 is also provided with a data processing system (e.g., 26) that may be identical or at least similar to the data processing system 26 described for the first embodiment. In one embodiment, the data processing system comprises a flash-based micro-controller, whereas the data processing system 26 described for the first embodiment utilizes a one-time programmable micro-controller. By way of example, the flash-based micro-controller utilized in one embodiment comprises a type 16F876 programmable micro-controller available from Microchip Technology, Inc. Electrical power to operate the various components of the radiation detector 110 may be provided by a lithium-ion rechargeable type battery (not shown) of the type that is readily commercially available.

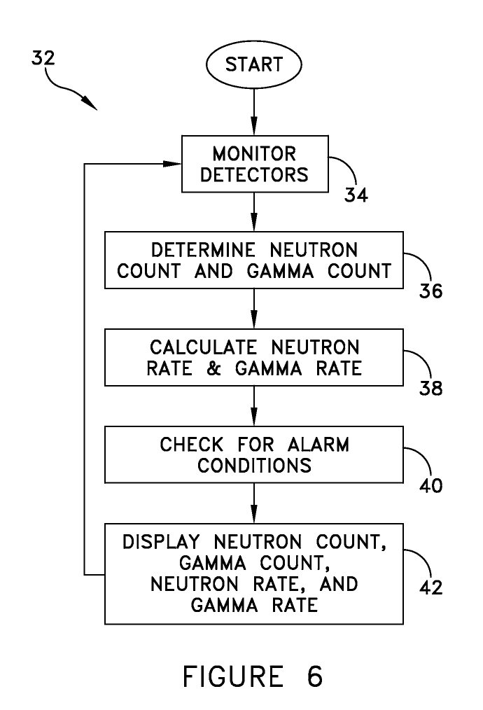

The output signals (e.g., 22 and 24, FIG. 2) comprising TTL pulses from the first and second detector systems (e.g., 18, 20, FIG. 2) are fed directly to the data processing system (e.g., 26) and are counted thereby. The data processing system monitors the output signals (e.g., 22 and 24) produced by the first and second radiation detection systems (e.g., 18 and 20) to calculate several different radiation parameters. For example, the total count (both neutrons and gamma radiation) is determined by adding together the lower level discriminated signals (e.g., 60 and 60′, FIG. 2), i.e., Li6LLD and Li7LLD (FIG. 5), for both the Li6 and Li7 detectors (e.g., 44 and 44′). The neutron count is calculated by subtracting the upper level discriminated signal (e.g., 58′) (Li7ULD) from the Li7 detector (e.g, 44′) from the upper level discriminated signal (e.g., 58) (Li6ULD) from the Li6 detector (e.g., 44). The gamma count is calculated by subtracting the neutron count from the total count.

The radiation detector 110 may be provided with an alarm system that may be identical to the alarm system 28 already described for the radiation detector 10. The alarm system (e.g., 28) provides the user with several different alarm signals if one or more of the radiation parameters exceeds a corresponding threshold level. The alarm signal may comprise any of a wide variety of indications, e.g., visual, aural, or tactile signals, or some combination thereof. However, because the alarm system of the radiation detector 110 may be identical to the alarm system 26 already described, the alarm system of embodiment 110 will not be described in further detail herein.

The radiation detector 110 may also be provided with a data interface system (e.g., 30) of the type described above for the first embodiment 10. The data interface system 30 allows data (e.g., radiation data) to be downloaded from the radiation detector to an external device (e.g., an external computer, a PDA, etc.) for additional analysis and/or archiving. The data interface system 30 may also be used to upload data (e.g., configuration information) to the radiation detector 110. The data interface system 30 may comprise any of a wide variety of data interface systems (e.g., a USB port, a wireless port, or an infra-red port) known in the art or that may be developed in the future.

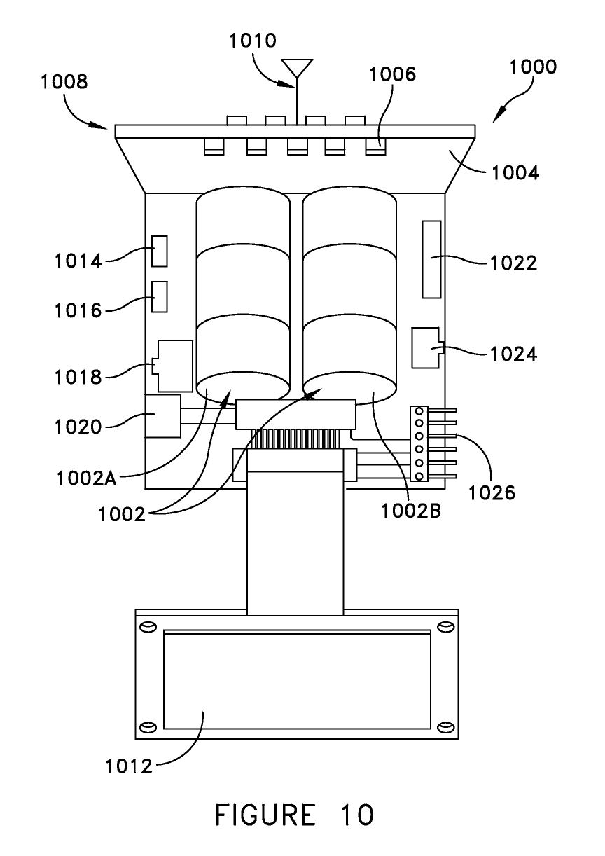

The radiation detector 110 may be operated in accordance with the method 132 illustrated in FIG. 8 in order to determine the presence, strength, and type (e.g., neutron or gamma) of radiation field. The method 132 may be implemented by programming the data processor (e.g., 26) in any convenient language (e.g., the “C” program language).

In the embodiment shown and described herein, the method 132 is used to determine, for each radiation type (i.e., neutron and gamma radiation) both total radiation detected (i.e., total “counts”), as well as radiation rate (i.e., “counts” per unit time). The total radiation as well as the radiation rate may be displayed on the display device 114 for each radiation type.

With reference now specifically to FIG. 8, in a first step 134 of method 132, the data processor (e.g., 26) monitors the two radiation detection systems (e.g., 18 and 20) by sensing the output signals (e.g., 22 and 24) produced by the respective first and second radiation detection systems (e.g., 18 and 20). In the embodiment shown and described herein, the monitoring step 134 is conducted on a per-second basis. That is, the data processor (e.g., 26) collects and processes the number of counts produced by each detector (e.g., 44 and 44′) during a one-second data collection interval. Alternatively, data collection intervals having durations other than one-second may also be used.

The number of counts for each one-second data collection interval is calculated in step 136 and is determined for each of total radiation (i.e., gamma plus neutron), neutron radiation, and gamma radiation, in the manner described above. That is, the total count is determined by adding together the lower level discriminated signals (e.g., 60 and 60′), whereas the neutron count is calculated by subtracting the upper level discriminated signal (e.g., 58′) produced by the Li7 detector from the upper level discriminated signal (e.g., 58) produced by the Li6 detector. The gamma count is then calculated by subtracting the neutron count from the total count. The number of counts is continually updated for each subsequent one-second data collection interval in order to maintain a running total of counts over a given sample time. For example, if the radiation detector 110 is operated for a sample time of 10 minutes, the number of counts at the end of the 10-minute sample time period will be the sum of the number of counts for each one-second data collection interval over the 10-minute sample time.

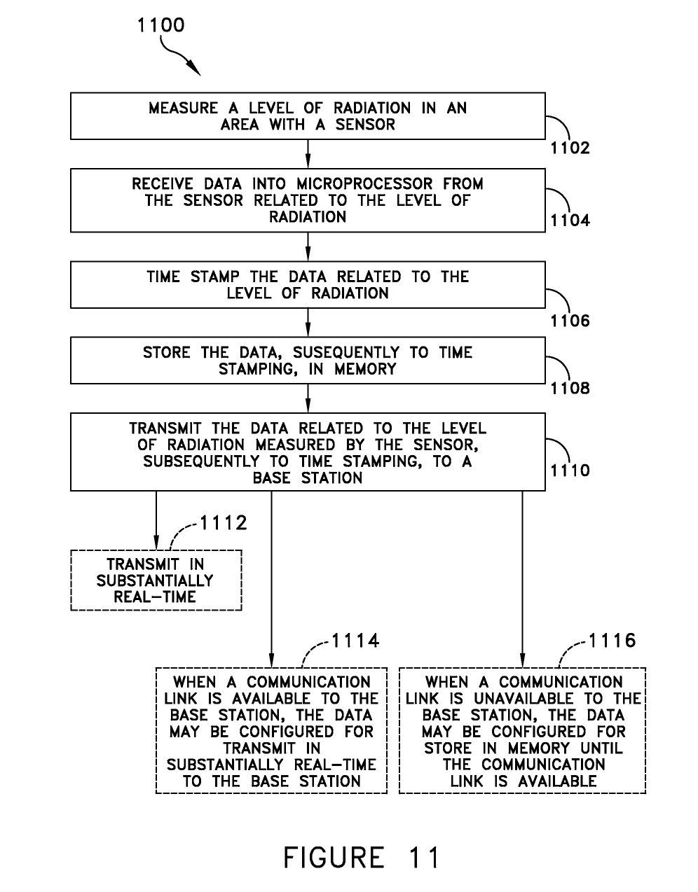

The count rate (i.e., rate of incoming radiation or radiation rate) is calculated during process 138. The count rate is a “rolling average” of the counts obtained during some number N (e.g., 8) of sequential one-second data collection intervals. With reference now to FIG. 9, a first step 140 in the process 138 sums N−1 sequential counts stored in the memory system (not shown) associated with the data processor (e.g., 26). For example, in one embodiment wherein the rolling average is computed over eight (8) sequential one-second data collection intervals, the first step 140 sums the first seven (7) counts stored in memory. At system start-up, it will take seven seconds to collect and store in memory the first seven counts from the respective detectors. Thereafter, the seven (7) counts stored in memory may be summed each second. The memory values are then rotated up one position in memory at step 142. The result of the rotation is that the first memory location is overwritten by the data contained in the second memory location, and so-on, thus making available the last memory location. The data for the next second (e.g., the 8th second) is then stored in the last memory location at step 144. The new data is then added to the previously-calculated sum at step 146. The average is then computed by dividing the sum by N at step 147.

The process 138 for computing a rolling average of count rates is implemented in one embodiment by utilizing a one-dimensional array of N−1 elements (e.g., a 7-element array where N=8). The number of counts for the first one-second data collection interval is stored in the first element of the array. Next, the number of counts for the second one-second data collection interval is stored in the second element of the array, and so on, until the number of counts for the seventh one-second data collection interval is stored in the seventh element of the array. The data are then summed at step 140. That is, the process 140 sums the number of counts for the seven stored one-second data collection intervals.

In order to make room in the array for storing the number of counts for the next time interval (e.g., the 8th second), the various counts are shifted one place in the array to make available the seventh element. The shifting is accomplished by storing in the first element of the array the number of counts stored in the second element of the array. The number of counts stored in the third element of the array is then stored in the second element in the array, and so on, until the number of counts in the seventh element of the array is stored in the sixth element in the array. The number of counts for the next time interval (e.g., the 8th second) is then stored in the seventh element of the array.

The number of counts for the 8th one-second data collection interval is then added to the sum of the number of counts for the 1st through the 7th one-second data collection intervals previously computed at step 140. The resulting sum is then divided by 8 to yield a first average of the counts over the eight one-second data collection intervals. This process is then repeated for each subsequent second. Therefore, the average count computed for each subsequent (i.e., current) second will represent the average of the counts for the current second and the counts for the previous seven seconds.

With reference back now to FIG. 8, step 148 checks for alarm conditions and activates the alarm system (e.g., 28, FIG. 1) if one or more alarm conditions are detected during the radiation monitoring process 132. By way of example, in one preferred embodiment, the radiation detector system 110 checks the total counts (e.g., for each of neutron and gamma radiation) against corresponding predetermined thresholds. The system 110 also checks the rolling average counts (e.g., for each of neutron and gamma radiation) against corresponding predetermined thresholds. If any total count or rolling average count rate exceeds its corresponding threshold, the data processing system (e.g., 26) activates the alarm system (e.g., 28) to alert the user that the total counts or rolling average count rate has exceeded the corresponding threshold.

The data processing system (e.g., 26) continuously displays the various counts (e.g., total counts for gamma and neutrons, as well as rolling average count rates for gamma and neutrons) on the display system 114, as depicted in step 150. As mentioned above, one embodiment of the radiation detector 110 is provided with three sensitivity settings, low, medium, and high, so that the detected radiation levels may be more effectively presented on the display device 114.

For example, and with reference back now to FIG. 7, the sensitivity for both the gamma counts (i.e., “G” in FIG. 7) and neutron counts (i.e., “N” in FIG. 7) may be independently selected. By way of example, in the embodiment shown and described herein, the sensitivity may be selected to be either a low, medium, or high sensitivity. An appropriate range indicator (e.g., “7” in for the gamma counts portion of the display and “1” for the neutron counts portion of the display) may be provided on the display device 114 to allow the user to more readily ascertain the true number of counts displayed for the particular sensitivity level. For example, in one embodiment, the display 114 is capable of displaying, for each of gamma counts “G” and neutron counts “N,” sixteen (16) blocks for a full-scale display reading. That is, a full scale reading of either gamma counts “G” and/or neutron counts “N” will display sixteen (16) blocks in the appropriate row. Thus, in the example illustrated in FIG. 7, the “7” range indicator for the gamma counts “G” row stands for a current reading of six (6) full-scale display readings (of 16 blocks each) plus the blocks in the current display (e.g., 3), for a total of 99 blocks (i.e., 16*6+3=99). Similarly, the “1” range indicator for the neutron counts “N” row stands for a current reading of no full-scale display readings, plus the blocks in the current display (e.g., 5) for a total of 5 blocks.

The data processing system (e.g., 26) continuously repeats the method 132, thereby providing the user with real-time data relating to both total radiation counts and the rolling average count rate. The continual repetition of the process 132 also allows the alarm system (e.g., 28) to be activated the moment one or more of the total counts or rolling average count rates exceed their respective thresholds.

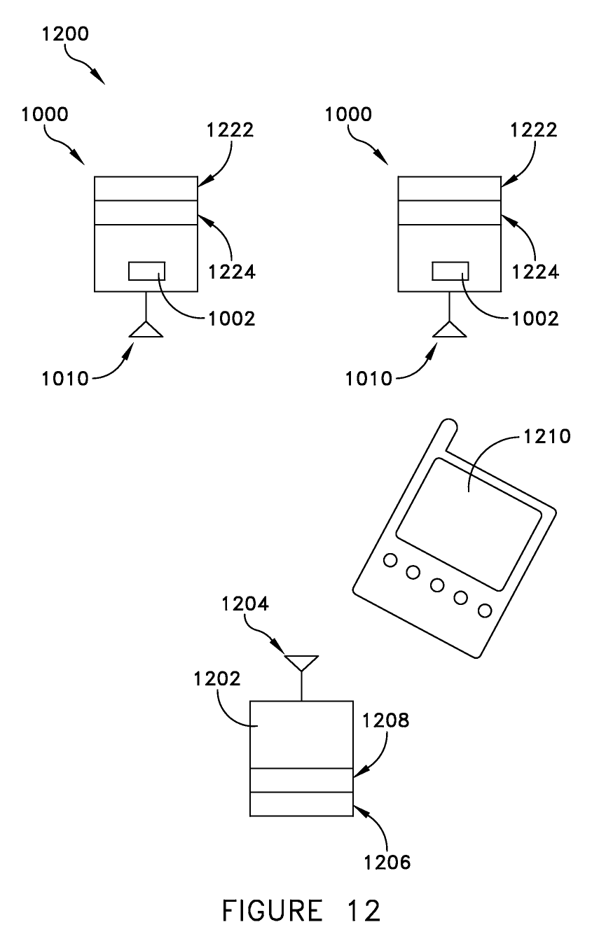

Now referring to FIG. 10, there is shown a network enabled radiation detection system 1000. In an embodiment, there may be provided one or more sensors 1002 configured for measuring a level of radiation in an area. For example, sensor 1002 is referred to herein below as a single unit. However, sensor 1002 may include a detector subsystem having two detectors 1002A and 1002B, which are described as an exemplary embodiment hereinbelow. For example, radiation detection system 1000 may detect gamma rays and neutrons in a radiation field as low as 50 μR/hr above the ambient background.

A microprocessor 1004 may be provided in communication with sensor 1002. Microprocessor 1004 may also be referred to as a high-voltage board 1004. Microprocessor 1004 may be configured for receiving data from sensor 1002 related to the measured level of radiation.

Memory 1006 is generally operatively associated with microprocessor 1004. Software code 1008 is generally operatively associated with memory 1006. In an embodiment, software code 1008 is contained within memory 1006. In another embodiment, the software code 1008 is contained externally to memory 1006. Software code 1008 may be configured for time stamping the measured data related to the level of radiation. Software code 1008 may also be configured for storing the measured data, subsequent to time stamping, in memory 1006.

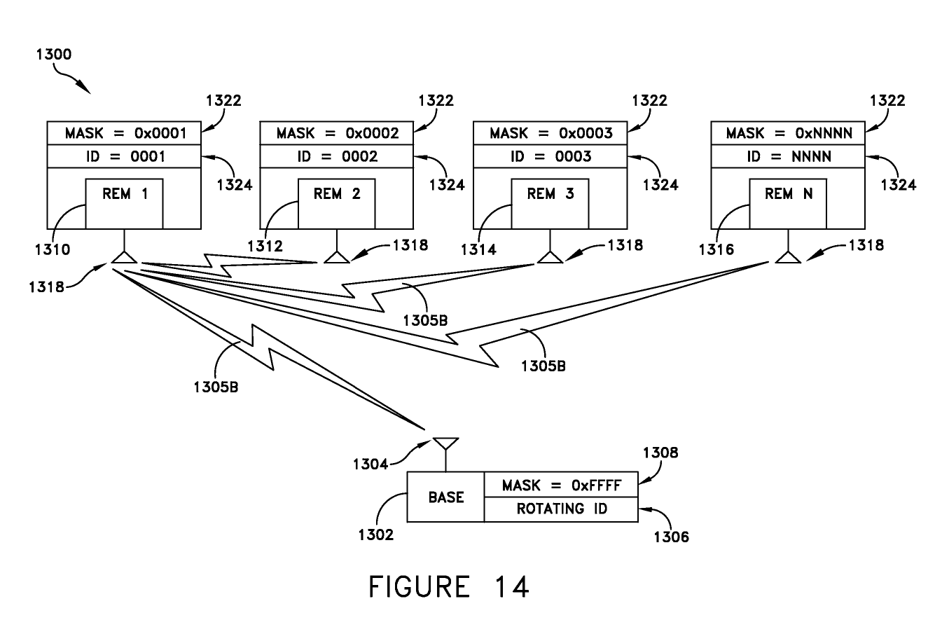

Wireless communication equipment 1010 may be operatively associated with memory 1006. Wireless communication equipment 1010 may be configured for transmitting a message with the measured data, subsequent to time stamping, to another device (e.g. a base station 1202 (FIG. 12)).

Equipment 1010 may include, for example, a network radio-frequency (RF) system may include the XC09-009 model transceiver module manufactured by MaxStream, Inc. of Lindon, Utah. In an embodiment, a wireless modem (i.e., base station 1202) may operate at a frequency range of 900 MHz. The transceiver may communicate with a remote device and download radiation data through walls at a distance of about 150 feet. For unobstructed (line-of-site) communications, the range of the module is about 850 to 900 feet. 109

As indicated above, detector 1002 may include several subsystems 1002A and 1002B, for example. Two Hamamatsu R7400U solid-state detectors 1002A and 1002B may form detector 1002. Each of the Hamamatsu R7400U solid-state detectors 1002A and 1002B may be contained in a cylindrical housing with a diameter of about 1.27 centimeters (0.5 inches) and a length of about 3.81 centimeters (1.5 inches). For example, and in an embodiment, the two detectors are made with different isotopes of lithium. Detector 1002A is made with lithium 6. Detector 1002B is made with lithium 7. Each detector 1002A and 1002B may be mounted on a photomuplier tube (PMT). Detector assemblies are connected to high-voltage board 1004.

The high-voltage board 1004 has an output voltage which may be remotely or locally programmable with a range of up to about 740 VDC through a digital potentiometer. For example, such a digital potentiometer may include model number AD5245, manufactured by Analog Devices of Norwood, Mass. The high-voltage subsystem is based on a Cockroft-Walton (CW voltage multiplier and is made of nine stages. A voltage divider is inserted between the 8th and 9th stages to allow a ½ voltage state output. This voltage is applied to the anode of the photomultiplier tubes. The CW high-voltage subsystem has been designed to operate with a supply voltage of about 3.3 VDC. The outputs of the PMTs are capacitively coupled with a pair of 1000 VDC-rated capacitors and directed to an analog processing subsystem composed of a pair of amplifier circuits, such as model number AD492 manufactured by Analog Devices of Norwood, Mass., and a set of level discriminators, such as a differential comparator model number TLC354C manufactured by Texas Instruments of Dallas, Tex.

In an embodiment, the components of the analog subsystem may be optimized to run with a supply voltage of about 3.3 VDC. The amplifiers shape, filter and amplify the low-level inputs generated by the PMTs. The gains for the amplifiers are controlled through a Dallas/Maxim DS 1803-050 programmable potentiometer, which can be controlled remotely. The outputs of the amplifier circuits are directed to the set of level discriminators. A pair of discriminators is included for each amplifier output. Each of the discriminator levels is controlled through a Dallas/Maxim DS 1803-100 remotely programmable digital potentiometer. The outputs of the discriminators are sent to the digital subsystem, which has also been optimized to operate with a supply voltage of about 3.3 VDC.

The first stage of the digital subsystem is made up of a set of 74HC123 pulse generators. There is one pulse generator for each discriminator output for a total of four pulse generators. The outputs from the pulse generators are directed to a microcontroller. There is one pulse generator for each discriminator output for a total of four pulse generators. The outputs from the pulse generators are directed to a microcontroller.

One such microcontroller is a Microchip PIC18LF2525 and operates at an external frequency of 10 Hz with a Linear Technology LTC6900 oscillator. The internal operational frequency of the microcontroller is set at 40 MHz with a phase-locked loop (PLL) option. The microcontroller contains the code to count the pulses from the pulse generator, and then to notify the remote or local user of the alarm condition, if any has been exceeded. The microcontroller also interfaces to the communications subsystem, made of an Intersil ICL3232 RS 232 device, and the storage subsystem, made up of an STI M41T81 realtime clock chip and a Microchip 24LC256 EEPROM memory chip. The microcontroller also writes data directly to a Varitronix MDLS-16263-C-XLV-G-LEDOG liquid crystal display. Power to the CW high-voltage subsystem may be controlled from the microcontroller through a Linear Technology LTC1477 switch. A small piezo-crystal speaker is included for audible alarm annunciations.

In an embodiment, there may also be provided an LCD display 1012 with a backlight switch 1014, a mute switch 1016, a power switch 1018, an external input 1020 (e.g., 5 VDC input), a test port 1022, an RS232 port 1024, or a programming port 1026.

Referring to FIG. 12, wireless communication equipment 1010 may be configured to transmit a message with an identifier (ID) 1224 associated therewith to another device (e.g. a base station 1202 (FIG. 12)). Base station 1202 may include a mask 1208 configured to identify the message with the identifier (ID) associated therewith so as to identify a specific remote device measuring the level of radiation.

Software code 1008 may be configured to activate an alert when the level of radiation measured by sensor 1002 exceeds a pre-selected level. In one embodiment, remote device 1000 may include programmable alarm trigger levels that can be modified for specific applications. In an embodiment, the alert may include a visual alarm signal. For example, the visual alarm signal may includes one or more of a flashing light, an LCD display, at least one LED, and a PDA. In one embodiment, the alert may include an aural alarm signal. For example, the aural alarm signal may include one or more of a tone, a buzzer, a beeper, and a PDA. In another embodiment, the alert may include a tactile alarm signal. For example, the tactile alarm signal may include a vibration.

In addition to, or in place of base station 1012, wireless communication equipment 1010 may be configured for transmitting a message with the measured data, subsequent to time stamping, to a PDA 1210. Also, in addition or in place of wireless connection equipment 1010, PDA 1210 may be configured to receive the data related to the level of radiation another device via a direct connection, e.g. RS232 port 1024.

A battery power source 1028 may be provided in connection with sensor 1002, microprocessor 1004, and wireless communication equipment 1010. In addition to, or instead of, battery power source 1028, a hardwired power source 1020 may be in connection with sensor 1002, microprocessor 1004, and wireless communication equipment 1010.

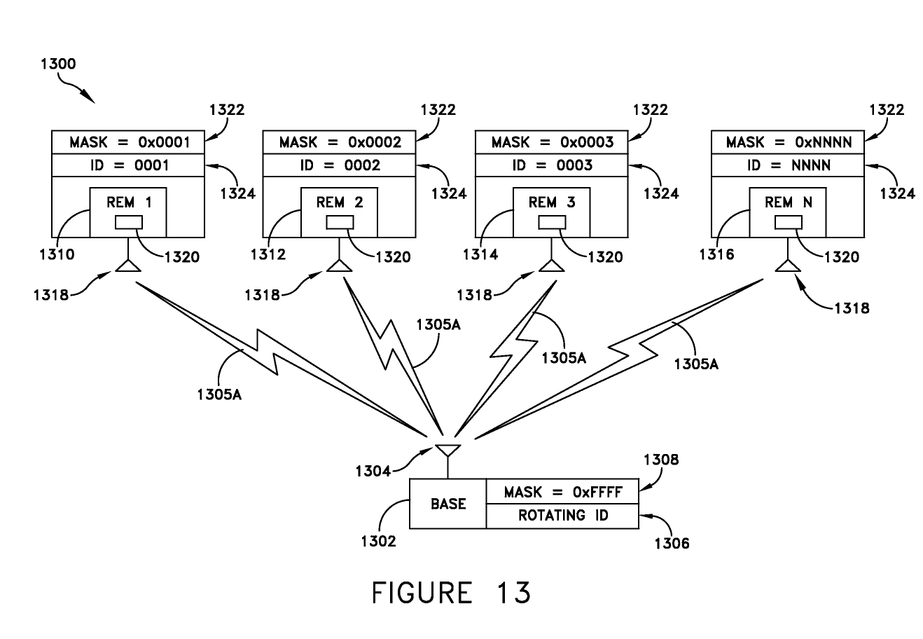

Looking now at FIG. 11, there is illustrated a method 1100 of monitoring radiation with a network enabled radiation detection system. In an embodiment, method 1100 may include measuring 1102 a level of radiation in an area with a sensor. Method 1100 may include receiving 1104 data into a microprocessor from the sensor related to the level of radiation. Method 1100 may include time stamping 1106 the data related to the level of radiation. Method 1100 may include storing 1108 the data, subsequent to time stamping, in memory. Method 1100 may include transmitting 1110 the data related to the level of radiation measured by the sensor, subsequent to time stamping, to a base station.

In one embodiment, the transmitting 1110 the data related to the level of radiation measured by the sensor, subsequent to time stamping, to the base station may be configured for transmitting 1112 in substantially real-time.

In another embodiment, the transmitting 1110 the data related to the level of radiation measured by the sensor, subsequent to time stamping, to the base station, when a communication link is available to the base station, the data may be configured for transmitting 1114 in substantially real-time to the base station, and, when the communication link is unavailable to the base station, the data may be configured for storing 1116 in memory until the communication link is available.

Referring to FIG. 12, there is illustrated a network enabled radiation monitoring system 1200. System 1200 may include a base station 1202. System 1200 may further include at least two network enabled radiation detection systems 1000.

Generally, and as best illustrated in FIG. 10, each one of detection systems 1000 may include one or more sensors 1002, microprocessor 1004, memory 1006, software code 1008, wireless communication equipment 1010.

For example, system 1200 may incorporate multiple devices in a distributed architecture with a central facility communicating though an RF link. The devices may be independently capable of storing time-tagged radiation data locally in the event of a failure of the RF communications link. When the RF link is restored, the locally stored data can be downloaded to the central facility.

In an embodiment, device 1000 may be designed to also allow a local connection with another device, such as PDA 1210, for portable applications. The device may be small enough to easily fit in a shirt pocket and run for two days on an internal battery, e.g., battery power source 1028.

Device 1000 may be configured to allow system parameters to be controlled remotely. This may allow a central facility (e.g., base station 1202) to dynamically modify alarm set points on a device by device basis.

Device 1000 may be configured to provide modular functionality for use in several operational modes. One mode may include stand-alone data collector as an interactive device indicating a “normal/alarm” condition. Another mode may provide a more detailed interactive device used for directional pinpointing of nuclear sources with emphasis on speed of detection as device 1000 may be configured in an extremely small size with very high sensitivity.

A logistic store of a few of devices 1000 may also allow interchangeability based on the specific application. A single device 1000 may be set to act as a member of a large distributed group to detect movements in a storage facility via an RF link to a central facility (e.g., base station 1210) or set to interface with a PDA (either with a wired connection or wirelessly) to give a first responder an indication of a radiation hazard prior to entering a scene. Logistical spare devices 1000 are minimized because the same unit may be used for multiple purposes.

As discussed above, device 1000 may be used in a stand-alone mode, or in conjunction with an array. As such, one or more remote devices 1000 may cover a small or large area. In an embodiment, device 1000 may be remotely configured by another device such base station 1202 or PDA 1210. Data may also be transferred and viewed on PDA 1210 via direct connection or wirelessly.

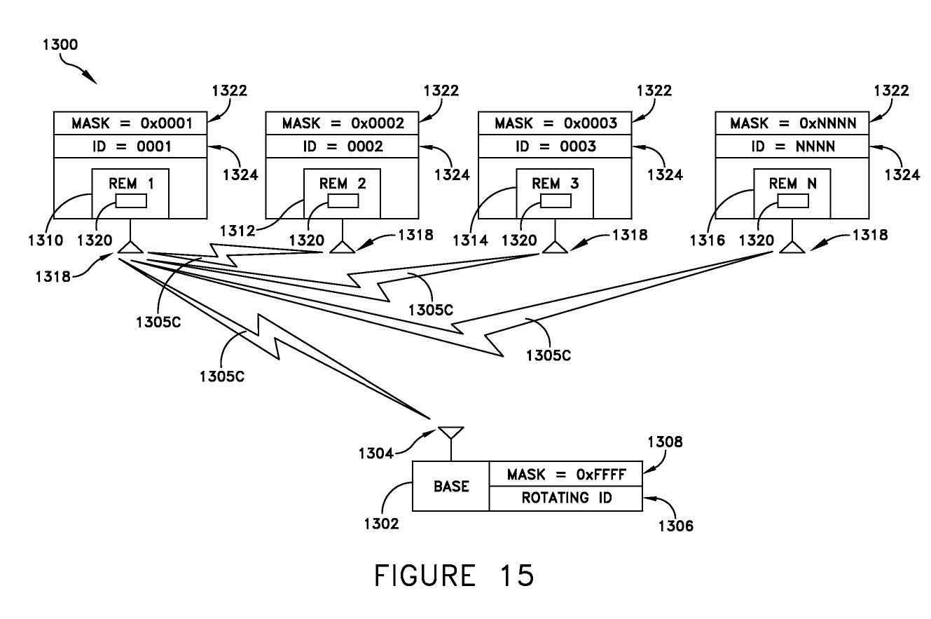

Looking at FIGS. 13-15, there is shown a communications system 1300. Communications system 1300 may include a base station 1302 with wireless communication equipment 1304 to transmit messages 1305A and 1305C (see FIG. 13 and 15, respectively) and receive messages 1305C (see FIG. 14). Base station 1302 may having a set of transmission identifiers (ID) 1306 and a mask 1308 for identifying messages 1305A and 1305C associated therewith.

A plurality of remote devices 1310-1316 have communication equipment 1318 configured for communication with base station 1302. Each one of remote devices 1310-1316 may have a sensor 1320, a mask 1322 associated therewith, and an identifier (ID) 1324 associated therewith.

Sensor 1320 of one or more of remote devices 1310-1316 may be configured to detect temperature. Sensor 1320 of one or more of remote devices 1310-1316 may be configured to detect humidity. Sensor 1320 of one or more of remote devices 1310-1316 may be configured to detect radiation.

Base station 1302 may be configured to load identifier (ID) 1306 of remote device 1310, for a selected one of the remote devices, and then send a message 1305A with the identifier (ID) 1306 for the selected one of the remote devices, e.g., remote device 1310, to all of the remote devices 1310-1318. The selected one of the remote devices, e.g., remote device 1310, may be configured to apply mask 1322 associated therewith to the identifier (ID) 1306 with the message, detect equality of the identifier (ID) 1306 and mask 1322, and accept message 1305A. Each of the unselected ones of the remote devices, e.g., remote devices 1312-1316, may be configured to apply the mask 1322 associated therewith to the identifier (ID) 1306 with the message, detect inequality of the identifier (ID) 1324 and the mask 1322, and discard the message.

As best illustrated in FIG. 14, the selected remote device, e.g., remote device 1310, may be configured to send an appropriate response message to base station 1302 and to the unselected ones of remote devices 1312-1318. Base station 1302 may be configured to apply the mask 1308 associated therewith to the identifier (ID) 1324 with the appropriate response message 1305B from the selected remote device, e.g., remote device 1310. Base station 1302 may be configured to detect equality of mask 1306 to identifier (ID) 1322 for the selected remote device, e.g., remote device 1310, and to, in turn, successfully pass the appropriate response message. The unselected ones of the remotes, e.g. remote devices 1312-1316, may be configured to apply the mask 1322 associated therewith to the identifier (ID) 1324 with the appropriate response message 1305B. The unselected remotes may be configured to detect inequality of the identifier (ID) 1324 and the mask 1322, and, in turn, discard the appropriate response message 1305B.

As best illustrated in FIG. 15, a selected remote device, e.g., remote device 1310, may be configured to send an alarm notification 1305C to the base station 1302 and to the other ones of the remote devices 1312-1316. Base station 1302 may be configured to apply the mask 1308 associated therewith to the identifier (ID) 1324 with alarm notification 1305C from the selected remote device, e.g., remote device 1310. Base station 1302 may be configured to detect equality of the mask 13208 to the identifier (ID) 1322 for the selected remote device, e.g., remote device 1310, and initiate a response to alarm notification 1305C. Each of the unselected ones of the remotes, e.g., 1312-1316, may be configured to apply the mask 1322 associated therewith to the identifier (ID) 1324 with the appropriate response message. Each of the unselected ones of the remotes, e.g., 1312-1316, may be configured to detect inequality of the identifier (ID) 1324 and the mask 1322, and discard the appropriate response message 1305C.

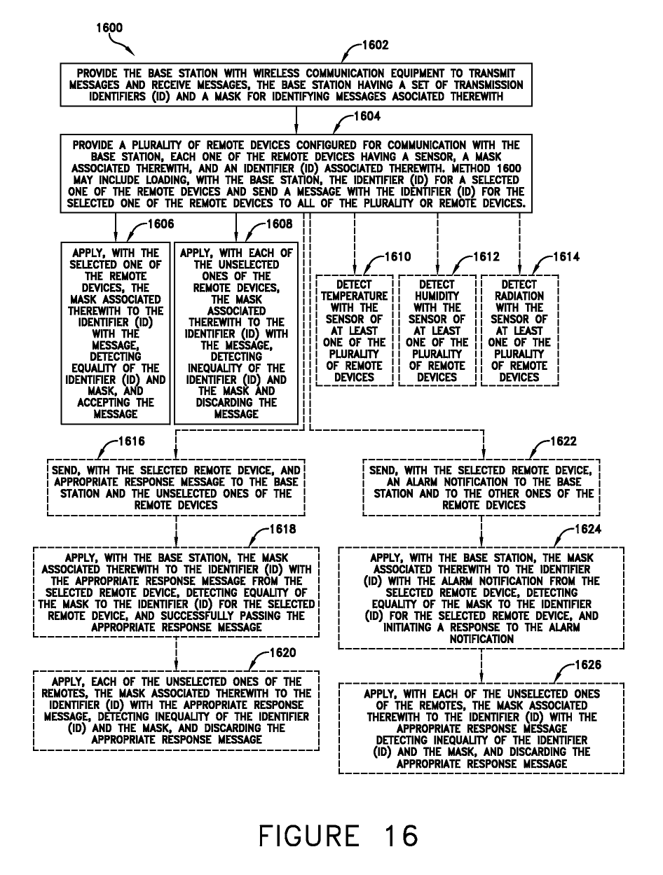

Looking at FIG. 16, there is illustrated a method 1600 of communicating between a base station and a plurality of remote devices. In an embodiment, method 1600 may include providing 1602 the base station with wireless communication equipment to transmit messages and receive messages, the base station having a set of transmission identifiers (ID) and a mask for identifying messages associated therewith.

Method 1600 may further include providing 1604 a plurality of remote devices configured for communication with the base station, each one of the remote devices having a sensor, a mask associated therewith, and an identifier (ID) associated therewith. Method 1600 may include loading, with the base station, the identifier (ID) for a selected one of the remote devices and send a message with the identifier (ID) for the selected one of the remote devices to all of the plurality of remote devices.

Method 1600 may further include applying 1606, with the selected one of the remote devices, the mask associated therewith to the identifier (ID) with the message, detecting equality of the identifier (ID) and mask, and accepting the message. Method 1600 may include applying 1608, with each of the unselected ones of the remote devices, the mask associated therewith to the identifier (ID) with the message, detecting inequality of the identifier (ID) and the mask, and discarding the message.

In one embodiment, method 1600 may optionally include detecting 1610 temperature with the sensor of at least one of the plurality of remote devices. In another embodiment, method 1600 may optionally include detecting 1612 humidity with the sensor of at least one of the plurality of remote devices. In an embodiment, method 1600 may optionally include detecting 1614 radiation with the sensor of at least one of the plurality of remote devices.

In an embodiment, method 1600 may optionally include sending 1616, with the selected remote device, an appropriate response message to the base station and to the unselected ones of the remote devices. Furthermore, method 1600 may include applying 1618, with the base station, the mask associated therewith to the identifier (ID) with the appropriate response message from the selected remote device, detecting equality of the mask to the identifier (ID) for the selected remote device, and successfully passing the appropriate response message. Method 1600 may include applying 1620, each of the unselected ones of the remotes, the mask associated therewith to the identifier (ID) with the appropriate response message, detecting inequality of the identifier (ID) and the mask, and discarding the appropriate response message.

In another embodiment, method 1600 may optionally include sending 1622, with the selected remote device, an alarm notification to the base station and to the other ones of the remote devices. Method 1600 may include applying 1624, with the base station, the mask associated therewith to the identifier (ID) with the alarm notification from the selected remote device, detecting equality of the mask to the identifier (ID) for the selected remote device, and initiating a response to the alarm notification. Method 1600 may include applying 1626, with each of the unselected ones of the remotes, the mask associated therewith to the identifier (ID) with the appropriate response message, detecting inequality of the identifier (ID) and the mask, and discarding the appropriate response message.

The present invention may provide a networked gamma and neutron radiation detection system for use with special nuclear material tracking and surveillance technologies to provide real-time alarm detection and notification of unauthorized nuclear activities. The detection system may be integrated with wireless network radiation monitoring systems or the detection system may be used as a stand-alone unit.

Having herein set forth preferred embodiments of the present invention, it is anticipated that suitable modifications can be made thereto which will nonetheless remain within the scope of the invention. The invention shall therefore only be construed in accordance with the following claims:

1. A network enabled radiation detection system, comprising:
a sensor configured for measuring a level of radiation in an area;
a microprocessor in communication with the sensor, and configured for receiving data from the sensor related to the level of radiation;
memory operatively associated with the microprocessor;
software code operatively associated with the memory, the software code configured for time stamping the data related to the level of radiation, and for storing the data, subsequent to time stamping, in the memory; and
wireless communication equipment operatively associated with the memory, and configured for transmitting a message with the data related to the level of radiation measured by the sensor, subsequent to time stamping, to another device.

2. A network enabled radiation detection system in accordance with claim 1, wherein the wireless communication equipment is configured to transmit the message with an identifier (ID) associated therewith to the another device.

3. A network enabled radiation detection system in accordance with claim 2, wherein the another device is a base station.

4. A network enabled radiation detection system in accordance with claim 3, wherein the base station comprises a mask configured to identify the message with the identifier (ID) associated therewith so as to identify a specific remote device measuring the level of radiation.

5. A network enabled radiation detection system in accordance with claim 1, wherein the software code is configured to activate an alert when the level of radiation measured by the sensor exceeds a pre-selected level.

6. A network enabled radiation detection system in accordance with claim 5, wherein the alert comprises a visual alarm signal.

7. A network enabled radiation detection system in accordance with claim 6, wherein the visual alarm signal includes at least one chosen from the group consisting of a flashing light, an LCD display, at least one LED, and a PDA.

8. A network enabled radiation detection system in accordance with claim 5, wherein the alert comprises an aural alarm signal.

9. A network enabled radiation detection system in accordance with claim 8, wherein the aural alarm signal includes at least one selected from the group consisting of a tone, a buzzer, a beeper, and a PDA.

10. A network enabled radiation detection system in accordance with claim 5, wherein the alert comprises a tactile alarm signal.

11. A network enabled radiation detection system in accordance with claim 10, wherein the tactile alarm signal includes a vibration.

12. A network enabled radiation detection system in accordance with claim 1, wherein the another device is a PDA.

13. A network enabled radiation detection system in accordance with claim 12, wherein the PDA is configured to receive the data related to the level of radiation another device via a direct connection.

14. A network enabled radiation detection system in accordance with claim 12, wherein the PDA is configured to receive the data related to the level of radiation another device via a wireless connection.

15. A network enabled radiation detection system in accordance with claim 1, further comprising a battery power source in connection with the sensor, the microprocessor, and wireless communication equipment.

16. A network enabled radiation detection system in accordance with claim 1, further comprising a hardwired power source in connection with the sensor, the microprocessor, and wireless communication equipment.

17. A method of monitoring radiation with a network enabled radiation detection system, the method comprising:
measuring a level of radiation in an area with a sensor;
receiving data into a microprocessor from the sensor related to the level of radiation;
time stamping the data related to the level of radiation;
storing the data, subsequent to time stamping, in memory; and
transmitting the data related to the level of radiation measured by the sensor, subsequent to time stamping, to a base station.

18. A method of monitoring radiation in accordance with claim 17, wherein the transmitting the data related to the level of radiation measured by the sensor, subsequent to time stamping, to the base station is configured for transmitting in substantially real-time.

19. A method of monitoring radiation in accordance with claim 17, wherein, when a communication link is available to the base station, the data is configured for transmitting in substantially real-time to the base station; and wherein, when the communication link is unavailable to the base station, the data is configured for storing in memory until the communication link is available.

20. A network enabled radiation monitoring system, comprising:
a base station; and
at least two network enabled radiation detection systems, each one of the detection systems comprising:
a sensor configured for measuring a level of radiation in an area;
a microprocessor in communication with the sensor, and configured for receiving data from the sensor related to the level of radiation;
memory operatively associated with the microprocessor;
software code operatively associated with the memory, the software code configured for time stamping the data related to the level of radiation, and for storing the data, subsequent to time stamping, in the memory; and
wireless communication equipment operatively associated with the memory, and configured for transmitting a message with the data related to the level of radiation measured by the sensor, subsequent to time stamping, to the base station.

21. A communications system, comprising:
a base station with wireless communication equipment to transmit messages and receive messages, the base station having a set of transmission identifiers (ID) and a mask for identifying messages associated therewith; and
a plurality of remote devices configured for communication with the base station, each one of the remote devices having a sensor, a mask associated therewith, and an identifier (ID) associated therewith.

22. A communications system in accordance with claim 21, wherein the sensor of at least one of the plurality of remote devices is configured to detect temperature.

23. A communications system in accordance with claim 21, wherein the sensor of at least one of the plurality of remote devices is configured to detect humidity.

24. A communications system in accordance with claim 21, wherein the sensor of at least one of the plurality of remote devices is configured to detect radiation.

25. A communications system in accordance with claim 21, wherein the base station is configured to load the identifier (ID) for a selected one of the remote devices and send a message with the identifier (ID) for the selected one of the remote devices to all of the plurality of remote devices; wherein the selected one of the remote devices is configured to apply the mask associated therewith to the identifier (ID) with the message, detect equality of the identifier (ID) and mask, and accept the message; and wherein each of the unselected ones of the remote devices is configured to apply the mask associated therewith to the identifier (ID) with the message, detect inequality of the identifier (ID) and the mask, and discard the message.

26. A communications system in accordance with claim 25, wherein the selected remote device is configured to send an appropriate response message to the base station and to the unselected ones of the remote devices; wherein the base station is configured to apply the mask associated therewith to the identifier (ID) with the appropriate response message from the selected remote device, detect equality of the mask to the identifier (ID) for the selected remote device, and successfully pass the appropriate response message; and wherein each of the unselected ones of the remotes is configured to apply the mask associated therewith to the identifier (ID) with the appropriate response message, detect inequality of the identifier (ID) and the mask, and discard the appropriate response message.

27. A communications system in accordance with claim 21, wherein a selected remote device is configured to send an alarm notification to the base station and to the other ones of the remote devices; wherein the base station is configured to apply the mask associated therewith to the identifier (ID) with the alarm notification from the selected remote device, detect equality of the mask to the identifier (ID) for the selected remote device, and initiate a response to the alarm notification; and wherein each of the unselected ones of the remotes is configured to apply the mask associated therewith to the identifier (ID) with the appropriate response message, detect inequality of the identifier (ID) and the mask, and discard the appropriate response message.

28. A method of communicating between a base station and a plurality of remote devices, comprising:
providing the base station with wireless communication equipment to transmit messages and receive messages, the base station having a set of transmission identifiers (ID) and a mask for identifying messages associated therewith; providing a plurality of remote devices configured for communication with the base station, each one of the remote devices having a sensor, a mask associated therewith, and an identifier (ID) associated therewith;
loading, with the base station, the identifier (ID) for a selected one of the remote devices and send a message with the identifier (ID) for the selected one of the remote devices to all of the plurality of remote devices;
applying, with the selected one of the remote devices, the mask associated therewith to the identifier (ID) with the message, detecting equality of the identifier (ID) and mask, and accepting the message; and
applying, with each of the unselected ones of the remote devices, the mask associated therewith to the identifier (ID) with the message, detecting inequality of the identifier (ID) and the mask, and discarding the message.

29. A method of communicating in accordance with claim 28, further comprising detecting temperature with the sensor of at least one of the plurality of remote devices.

30. A method of communicating in accordance with claim 28, further comprising detecting humidity with the sensor of at least one of the plurality of remote devices.

31. A method of communicating in accordance with claim 28, further comprising detecting radiation with the sensor of at least one of the plurality of remote devices.

32. A method of communicating in accordance with claim 28, further comprising:
sending, with the selected remote device, an appropriate response message to the base station and to the unselected ones of the remote devices;
applying, with the base station, the mask associated therewith to the identifier (ID) with the appropriate response message from the selected remote device, detecting equality of the mask to the identifier (ID) for the selected remote device, and successfully passing the appropriate response message; and
applying, each of the unselected ones of the remotes, the mask associated therewith to the identifier (ID) with the appropriate response message, detecting inequality of the identifier (ID) and the mask, and discarding the appropriate response message.

33. A method of communicating in accordance with claim 28, further comprising:
sending, with the selected remote device, an alarm notification to the base station and to the other ones of the remote devices;
applying, with the base station, the mask associated therewith to the identifier (ID) with the alarm notification from the selected remote device, detecting equality of the mask to the identifier (ID) for the selected remote device, and initiating a response to the alarm notification; and
applying, with each of the unselected ones of the remotes, the mask associated therewith to the identifier (ID) with the appropriate response message, detecting inequality of the identifier (ID) and the mask, and discarding the appropriate response message.
